(19) United States
(12) Patent Application Publication
(10) Pub. No.: US 2010/0095159 A1
(43) Pub. Date: Apr. 15, 2010

(54) APPARATUS AND METHOD FOR AUTOMATIC TESTING OF SOFTWARE OR DIGITAL DEVICES

(76) Inventors: Sung-won JEONG, Suwon-si (KR); Hyung-hun Cho, Suwon-si (KR); Meong-chul Song, Suwon-si (KR); Yun-gun Park, Suwon-si (KR); Sung-hoon Kim, Seoul (KR); In-Pyo Iiong, Suwon-si (KR)

Correspondence Address: North Star Intellectual Property Law, PC, P.O. Box 34688, Washington DC, DC, 20043, US

(21) Appl. No.: 12/467,652

(22) Filed: May 18, 2009

(30) Foreign Application Priority Data
Oct. 14, 2008 (KR) 10-2008-0100629

(51) Int. Cl. G06F 11/36; G06F 11/22

(52) U.S. Cl. 714/38; 714/48; 714/E11.145; 714/E11.208

(57) ABSTRACT

An apparatus and method for testing a digital device or software installed in the digital device are provided. According to one aspect, the apparatus for testing the digital device or software installed in the digital device includes a test agent for providing a test execution environment, and the test agent performs a test for each test case in response to a command from a test director. The test agent may report an execution state of the test to the test director, and the test director may generate a test result report based on the report or resumes the test upon generation of error.

### CROSS-REFERENCE TO RELATED APPLICATION

This application claims the benefit under 35 U.S.C. §119(a) of Korean Patent Application No. 10-2008-0100629, filed on Oct. 14, 2008 in the Korean Intellectual Property Office, the disclosure of which is incorporated herein in its entirety by reference.

### BACKGROUND

1. Field

The following description relates to an apparatus and method for automatic testing of software or digital devices with software installed therein.

2. Description of the Related Art

With development of various digital devices, software installed in such digital devices is becoming more diversified. Also, due to the assortment of digital devices, the execution environments of software installed in such digital devices are becoming increasingly different and, accordingly, test execution environments are also becoming increasingly complex.

In order to test a certain device, the software under test has to be executed according to test cases. However, if errors that are not controllable by users (such as a crash, hang, or the like) are generated due to improper operations of the device while executing the test cases of the device, data stored in the test result registry of the device may not be accessible, and thus the users will not be able to know the execution results of the test cases.

In this case, the test cases should be re-executed from the beginning under monitoring by a user. However, if the execution time is too long, time and manpower may be unnecessarily lost.

Further, if software under test is installed in devices with different operating systems, compliers, or CPUs, corrections of user test case codes, compilation, and building may be done whenever a test is performed, which prevents reuse of test cases and increases test costs.

### SUMMARY

In one general aspect, an apparatus for testing a digital device or software installed in the digital device according to at least one test case, includes a test agent configured to provide a test execution environment for the digital device, and to execute the test according to each test case, and a test director configured to provide each test case and the test agent to the digital device, to control the test agent to execute the test, and to monitor an execution state of the test or an execution result of the test.

In response to execution of the test being stopped due to generation of error upon testing, the test director may be configured to return test cases that have not been executed to the digital device, and to issue a command to the test agent to resume the test from the location at which the error is generated.

The test director may be configured to generate a report including execution results of the tests performed prior to the generation of the error.

The remaining test cases may be returned to the digital device, except for a test case in which an error has been generated.

The test director may be configured to classify the test cases according to their operations and to provide the test cases to the digital device individually for each operation.

The test agent and each test case may be compiled and ported together to the digital device, or may be transmitted individually to the digital device

The test agent may be configured to transfer the execution result of the test to the test director whenever execution of each test case is complete.

The apparatus may further include a test case generator configured to create a code for each test case, based on information for software under test or basic information for the test case.

The test case generator may be configured to receive or generate at least one of an input value of each test case, an execution condition, an expected value, and a stub code, which is generated by processing a specific code to be compilable or which replaces a specific function.

The code for each test case may include a test case template code.

The test case generator may be configured to generate each test case using a function-based process or a scenario-based process.

The information for the software under test may include a code or code file of the software under test, and the basic information for each test case may include at least one among an input value, an expected value, and an execution condition for the test case.

In another general aspect, a method for testing a digital device or software under test installed in the digital device according to at least one test case, includes providing a test agent to the digital device, the test agent configured to provide the at least one test case and a test execution environment for the digital device, and executing the test according to each test case, issuing a command to the test agent to execute the test, and monitoring a test execution state or a test execution result by receiving a report from the test agent.

The method may further include determining whether execution of a test is stopped due to generation of an error upon testing, in response to the execution of the test being stopped, returning test cases to be executed after the generation of error to the digital device, and issuing a command to the test agent to resume the test from a location at which the error has been generated, and generating a report including an execution result of the tests performed prior to the generation of the error.

The test agent and each test case may be compiled and ported together to the digital device, or may be transmitted individually to the digital device.

The method further may further include generating a test case code based on information for software under test or basic information for each test case from a user, and generating each test case using the test case code.

The information for the software under test may include a code or code file of the software under test, and the basic information for each test case may include at least one among an input value, an expected value, and an execution condition for the test case.

The generating of each test case may include receiving or generating at least one of an input value of each test case, an execution condition, an expected value, and a stub code which is generated by processing a specific code to be compilable and which replaces a specific function.

The code for each test case may include a test case template code.

Other features and aspects will be apparent from the following detailed description, the drawings, and the claims.

### BRIEF DESCRIPTION OF THE DRAWINGS

FIG. 1 is a diagram illustrating an exemplary test automation apparatus.

FIG. 2 is a diagram illustrating an exemplary test case being executed.

FIG. 3 is a diagram illustrating an exemplary test automation apparatus.

FIG. 4 is a flowchart illustrating an exemplary method of generating test cases.

FIG. 5 is a diagram illustrating an exemplary schematic configuration of a test agent.

FIG. 6 is a diagram illustrating an exemplary schematic configuration of a test director.

FIG. 7 is a diagram illustrating an exemplary test automation method.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION

The following detailed description is provided to assist the reader in gaining a comprehensive understanding of the methods, apparatuses, and/or systems described herein. Accordingly, various changes, modifications, and equivalents of the systems, apparatuses, and/or methods described herein will be suggested to those of ordinary skill in the art. Also, descriptions of well-known functions and constructions may be omitted for increased clarity and conciseness.

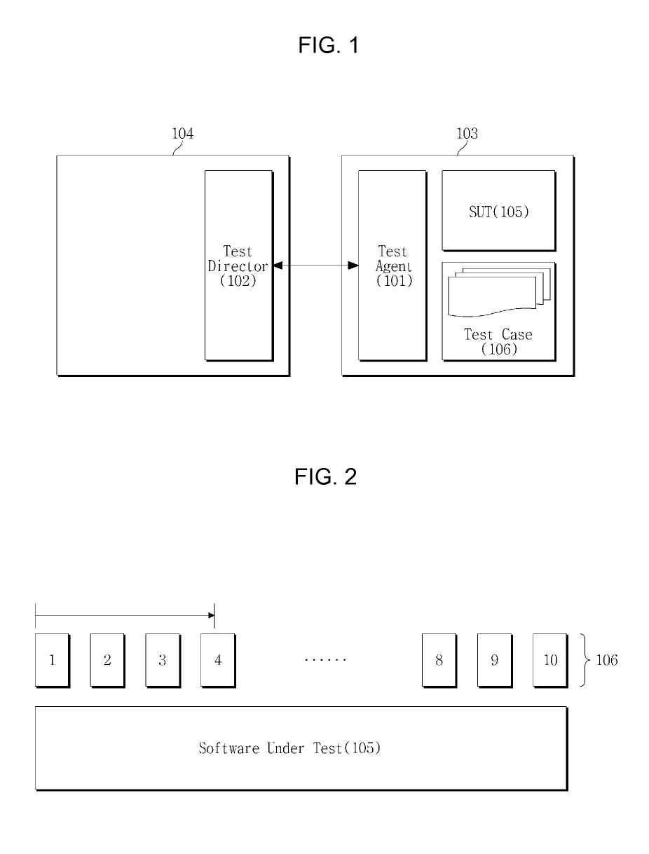

FIG. 1 is a diagram illustrating an exemplary test automation apparatus.

Referring to FIG. 1, the test automation apparatus includes a test agent 101 and a test director 102.

The test agent 101 is installed in a digital device 103 that is to be tested, and the test director 102 is installed in a host PC 104 which controls the entire test processing. As one example, if a mobile phone or software installed in the mobile phone is tested by connecting the mobile phone to a PC, the mobile phone corresponds to the digital device 103 and the PC corresponds to the host PC 104.

The test agent 101 installed in the digital device 103 provides a test execution environment to the digital device 103. As one example, software under test (SUT) 105 installed in the digital device 103 is executed according to each test case 106 by the test agent 101. The test agent 101 may control the functions of the digital device 103 or provide a user interface.

Here, the test case 106 includes a group of test input values, execution conditions, expected result values, and the like to test a certain program. As one example, the test case 106 installed in the digital device 103 is a test suite consisting of a plurality of test cases. Each test case 106 may be accessed directly by a user through a predetermined software tool, or may be generated automatically by only receiving basic information from a user.

The test director 102 provides the test agent 101, software under test 105 and test case 106 to the digital device 103. As one example, the test director 102 builds the test agent 101, software under test 105, and test case 106 in the form of a binary file or image file, and ports the binary file or image file to the digital device 103. As another example, the test agent 101 and the software under test 105 are built together by the test director 102 and then ported to the digital device 103, while the test case 106 is separately transmitted to the digital device 103.

The test director 102 controls the test agent 101 for executing a test. As one example, the test director 102 issues commands regarding the start, stop, or completion of the test to the test agent 101, and the test agent 101 executes the test in response to the commands from the test director 102.

The test director 102 monitors test processing by receiving the execution status or execution results of the test from the test agent 101.

Herein, the term “monitoring” includes a series of processes for managing the overall execution statues of the test and for drawing up reports or controlling test processing when, as an example, the test processing execute as intended. As one example, the test agent 101 transmits a report for the execution results of the test to the test director 102 whenever execution of each test case 106 is complete. If the test director 102 has received no report for the execution results of the test within a predetermined period of time, the test director 102 determines that an error has occurred and may draw up a report for a current execution result of the test and instruct the test agent 101 to resume the test.

This process will be described further with reference to FIG. 2, wherein a reference number 105 represents software under test and a reference number 106 represents 10 test cases.

As one example, in FIG. 2, it is assumed that an error has been generated in the fourth test case upon testing on the first through tenth test cases. In this example, the test agent 101 (see FIG. 1) reports the execution result values and log of each test case whenever execution of the test case is complete. FIG. 2 illustrates one example where the test director 102 (see FIG. 1) has received the execution results of the first through third test cases, but test processing on the fourth through tenth test cases has been stopped due to generation of error. Accordingly, the test director 102, which has received no report from the test agent 101 within a predetermined period of time, determines that an error has been generated upon testing. Accordingly, the test director 102 provides the fifth through tenth test cases to the digital device 103, excluding the fourth test case in which the error has been generated, and instructs the test agent 101 to resume the test.

At this time, the test director 102 may draw up a report about the test results so far executed and the fact that the error has been generated upon execution of the third test case.

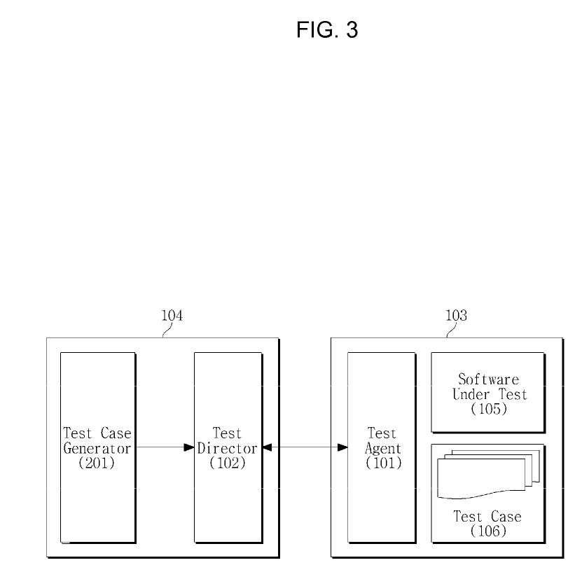

FIG. 3 is a diagram illustrating an exemplary test automation apparatus.

Referring to FIG. 3, the test automation apparatus includes a test agent 101, a test director 102 and a test case generator 201. Herein, the test agent 101 and test director 102 have been described above and accordingly detailed descriptions thereof will be omitted.

The test case generator 201 receives information for software under test or basic information about test cases, generates test case codes based on the information, and generates test cases based on the test case codes.

Herein, the test case codes may be test case codes or test case template codes with readability and reusability. Also, the information about software under test may be codes or code files for software under test, and the basic information about test cases may include input values, expected result values, execution conditions, and the like for the test cases. Additionally, the test case generator 201 may generate the test case codes by using a stub code, which is obtained by processing specific codes to be compilable or which replaces a specific function.

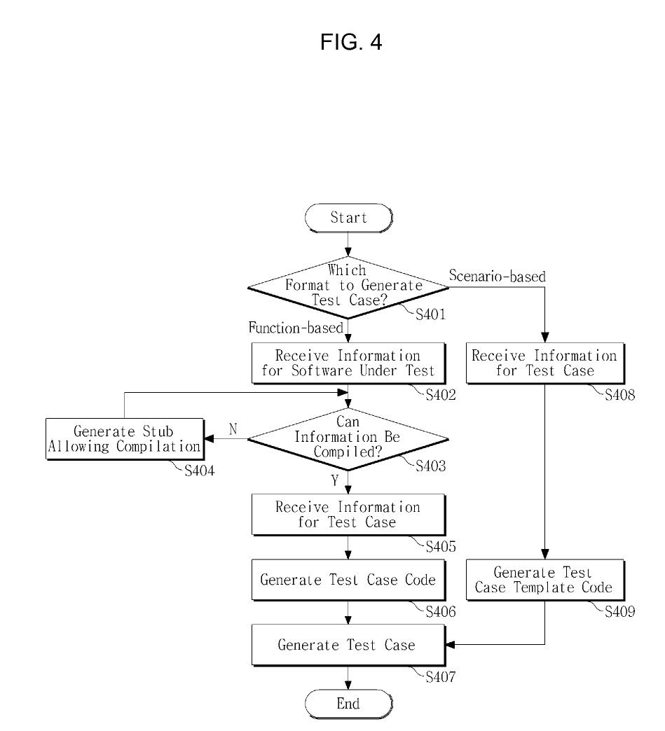

FIG. 4 is a flowchart illustrating an exemplary method of generating test cases in the test case generator 201.

The test case generating method may be divided to a function-based test and a scenario-based test according to formats for generating the test cases. The function-based test executes a test on software under test in units of functions. The scenario-based test executes a test on software under test according to a use scenario of the software under test, including its functions and non-functions.

To generate the test cases, in operation S401, it is determined whether to generate the test cases based on the function-based process or scenario-based process. The determination may be based on a user's input, and, as one example, the test case generator 201 may provide a user input interface.

Generating the test cases based on the function-based process and based on the scenario-based process will be described with reference to FIGS. 3 and 4, below.

For generating the test cases based on the function-based process, the test generator 201 receives all or some codes of software under test or a code file of the software from a user (operation S402).

The test case generator 201 analyzes the received codes or code file and determines whether they can be compiled (operation S403).

If the codes or code file cannot be compiled, the test case generator 201 generates a stub code for compiling the codes or code file based on the grammatical rules of programming languages, such as C, C++, or Java (operation S404).

If the codes or code file can be compiled, the test case generator 201 receives basic information for test cases from the user (operation S405). As one example, the basic information for test cases may include input values of test cases, expected values, stub values replacing specific functions, codes for checking the generation of errors, and the like. These values may be received from the user as described above, or all or some of the values may be generated automatically by the test case generator 201.

Successively, test case codes are generated based on the basic information for test cases (operation S406), and test cases are generated using the test case codes (operation S407). Herein, the test cases may be a test suite consisting of a plurality of test cases.

For generating the test cases based on the scenario-based process, the test case generator 201 is plugged-in to one of various integrated development environment (IDE) software (MS, VC++6.0, MS.NET, MS VC++2005, and the like) to receive information such as the names of test cases from the user (operation S408), and generates readable test case template codes with standard coding rules using the received information (operation S409).

The test cases generated by one of the above-described processes may be built together with the test agent 101, which provides a test environment to the digital device 103, and then ported to the digital device 103, or may be transmitted individually to the digital device 103.

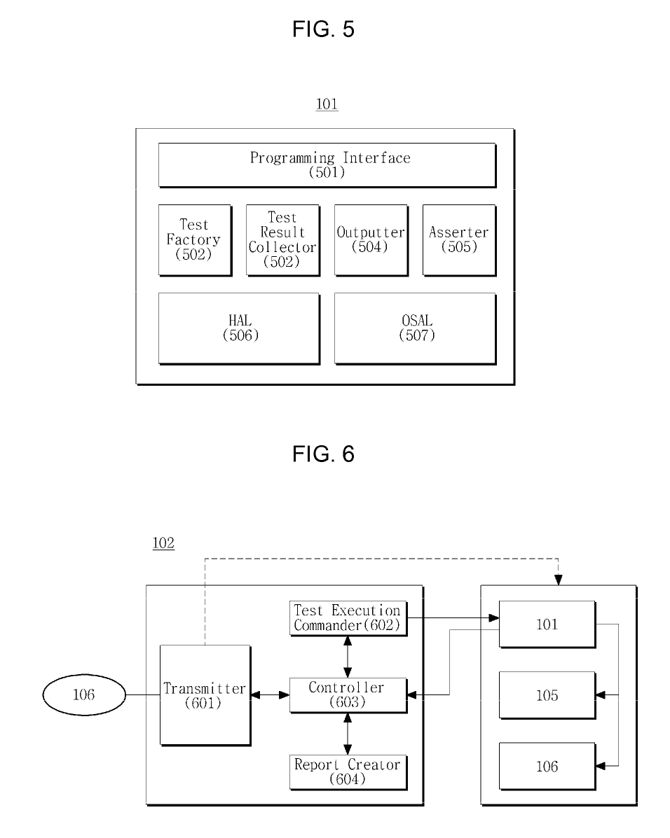

FIG. 5 is a diagram illustrating an exemplary schematic configuration of the test agent 101.

Referring to FIG. 5, the test agent 101 includes a programming interface 501 for ensuring the exact implementation of test cases in different execution environments, a test factory 502 for managing test cases in a device in which software under test will be installed, a test result collector 503 for collecting, analyzing, and/or managing test results, an outputter 504 for outputting the execution results of test cases in various forms, and an asserter 505 for comparing the test result values with expected values. For testing test cases generated on devices without any code correction, a test agent suitable for the environment of each device is provided. In order to provide an appropriate test agent for each device with minimal corrections, the test agent 101 may further include Hardware Abstraction Layer (HAL), Operating System Abstraction Layer (OSAL), and the like.

The test agent 101 may be built automatically by the test director 102 (see FIG. 3) and installed in the digital device 103. Also, the test agent 101 may control the digital device 103 directly, or control the execution operations of test cases. Additionally, the test agent 101 may report the execution states or results of testing to the test director 102.

FIG. 6 is a diagram illustrating an exemplary schematic configuration of the test director 102.

Referring to FIG. 6, the test director 102 may include a transmitter 601, a test execution commander 602, a controller 603, and a report creator 604.

The transmitter 601 transmits a test agent 101, software under test (SUT) 105, and test cases 106 to the digital device 103 (see FIG. 3). A transmission method in which the digital device 103 is connected to the test director 102 wired or wirelessly and the test director 102 provides the corresponding file to the digital device 103 through a communication line may be used. As one example, the transmitter 601 builds the test cases 106 and test agent 101, and ports them to the digital device 103. Herein, the test cases 106 and test agent 101 may be formed as an image file or as separate image files. It is also possible to transmit the test cases 106 and test agent 101 respectively to the digital device 103 through a communication line.

If a system level test is to be executed, the transmitter 601 may analyze the test cases 106 to divide them according to operations, and then transmit the test cases 106 for each operation. In this case, the transmitter 601 includes a syntax for classifying test cases according to operations, using predefined symbols and texts.

The test execution commander 602 issues a command to the test agent 101 such that the digital device 101 or software installed in the digital device 101 are executed according to the test cases 106.

The test agent 101 performs the corresponding test in response to the command from the test execution commander 602, and transmits a report regarding the execution states or results of the test to the controller 603.

The controller 603 determines whether any error is generated based on the report of the test agent 101. When an error is generated, the controller 603 issues a command to the transmitter 601 to re-transmit the test cases 106 to the digital device 103, and then issues a command to the test agent 101 to resume the test. The controller 603 controls the report creator 604 to generate a report (as one example, spreadsheet file) regarding the execution of the test executed to the point of the error.

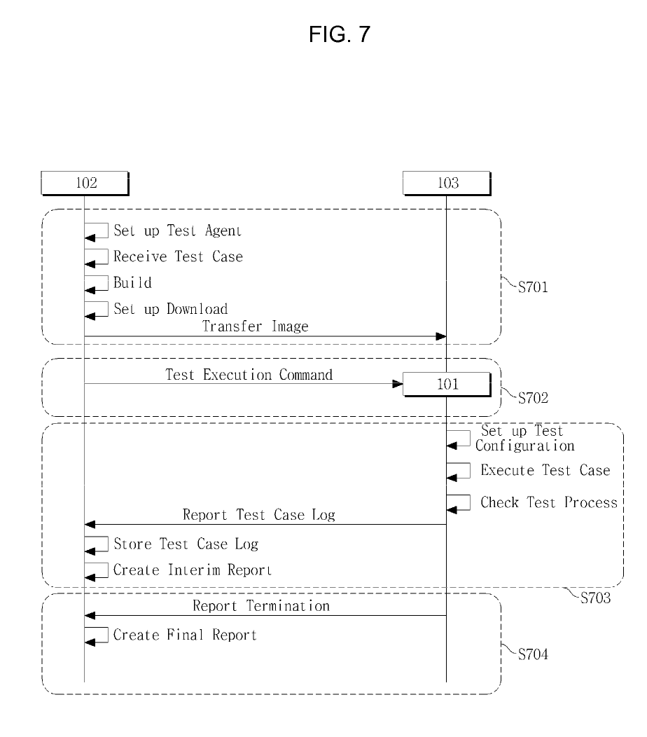

FIG. 7 is a diagram illustrating an exemplary test automation method.

Referring to FIG. 7, the test automation method includes a test director 102 transmitting an image to a digital device 103 (operation S701), the test director 102 issuing a test execution command to a test agent 101 (operation S702), the test agent 101 performing the test in the digital device 103 (operation S703), and the test director 102 creating a report when the test is terminated (operation S704).

In operation S701, the test director 102 sets up an initial environment for the test agent 101, providing a test execution environment for the digital device 103, and generates a test case. Successively, the test case and test agent 101 are built and subjected to download settings, and the corresponding image is transferred to the digital device 103. The software under test may be downloaded together with the test agent 101 and/or the test case.

In operation S702, the test director 102 issues a test execution command to the test agent 101. The test execution command may be a command for operating the software under test and executing it for each test case.

In operation S703, the test is performed by the test agent 101. The test agent 101 may control the digital device 103 and the test execution environment to set up a test configuration, execute the test case, and check the test process. The test agent 101 may send a test case log to the test director 102 whenever execution of each test case is complete. The test director 102 may store the received test case log therein and generate an interim report.

If no test case log is received within a predetermined time period, the test director 102 determines that an error has been generated. At this time, the process may return to operation S701. That is, if the test process is stopped, the test director 102 may return test cases to be executed after the generation of error to the digital device 103, and issue a command to the test agent 101 to resume the test from the location at which the error has been generated. Also, upon generation of error, a report may be generated and the test case in which the error has been generated may be excluded when the test cases are resumed and provided.

If the test is terminated, in operation S704, the test agent 101 transmits a report indicating the termination of test to the test director 102, and the test director 102 terminates the test and generates a final report in response to the report indicating the termination of test.

The methods described above may be recorded, stored, or fixed in one or more computer-readable media that includes program instructions to be implemented by a computer to cause a processor to execute or perform the program instructions. The media may also include, alone or in combination with the program instructions, data files, data structures, and the like. Examples of computer-readable media include magnetic media, such as hard disks, floppy disks, and magnetic tape; optical media such as CD ROM disks and DVDs; magneto-optical media, such as optical disks; and hardware devices that are specially configured to store and perform program instructions, such as read-only memory (ROM), random access memory (RAM), flash memory, and the like. Examples of program instructions include machine code, such as produced by a compiler, and files containing higher level code that may be executed by the computer using an interpreter. The described hardware devices may be configured to act as one or more software modules in order to perform the operations and methods described above, or vice versa.

A number of exemplary embodiments have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. An apparatus for testing a digital device or software installed in the digital device according to at least one test case, comprising:
a test agent configured to provide a test execution environment for the digital device, and to execute the test according to each test case; and
a test director configured to provide each test case and the test agent to the digital device, to control the test agent to execute the test, and to monitor an execution state of the test or an execution result of the test.

2. The apparatus of claim 1, wherein, in response to execution of the test being stopped due to generation of error upon testing, the test director is configured to return test cases that have not been executed to the digital device, and to issue a command to the test agent to resume the test from the location at which the error is generated.

3. The apparatus of claim 2, wherein the test director is configured to generate a report including execution results of the tests performed prior to the generation of the error.

4. The apparatus of claim 2, wherein the remaining test cases are returned to the digital device, except for a test case in which an error has been generated.

5. The apparatus of claim 1, wherein the test director is configured to classify the test cases according to their operations and to provide the test cases to the digital device individually for each operation.

6. The apparatus of claim 1, wherein the test agent and each test case are compiled and ported together to the digital device.

7. The apparatus of claim 1, wherein the test agent and each test case are transmitted individually to the digital device.

8. The apparatus of claim 1, wherein the test agent is configured to transfer the execution result of the test to the test director whenever execution of each test case is complete.

9. The apparatus of claim 1, further comprising a test case generator configured to create a code for each test case, based on information for software under test or basic information for the test case.

10. The apparatus of claim 9, wherein the test case generator is configured to receive or generate at least one of an input value of each test case, an execution condition, an expected value, and a stub code, which is generated by processing a specific code to be compilable or which replaces a specific function.

11. The apparatus of claim 9, wherein the code for each test case comprises a test case template code.

12. The apparatus of claim 9, wherein the test case generator is configured to generate each test case using a function-based process or a scenario-based process.

13. The apparatus of claim 9, wherein the information for the software under test comprises a code or code file of the software under test, and the basic information for each test case comprises at least one among an input value, an expected value, and an execution condition for the test case.

14. A method for testing a digital device or software under test installed in the digital device according to at least one test case, comprising:
providing a test agent to the digital device, the test agent configured to provide the at least one test case and a test execution environment for the digital device, and executing the test according to each test case;
issuing a command to the test agent to execute the test; and
monitoring a test execution state or a test execution result by receiving a report from the test agent.

15. The method of claim 14, further comprising:
determining whether execution of a test is stopped due to generation of an error upon testing;
in response to the execution of the test being stopped, returning test cases to be executed after the generation of error to the digital device, and issuing a command to the test agent to resume the test from a location at which the error has been generated; and
generating a report including an execution result of the tests performed prior to the generation of the error.

16. The method of claim 14, wherein the test agent and each test case are compiled and ported together to the digital device.

17. The method of claim 14, wherein the test agent and each test case are transmitted individually to the digital device.

18. The method of claim 14, further comprising generating a test case code based on information for software under test or basic information for each test case from a user, and generating each test case using the test case code.

19. The method of claim 18, wherein the information for the software under test comprises a code or code file of the software under test, and the basic information for each test case comprises at least one among an input value, an expected value, and an execution condition for the test case.

20. The method of claim 18, wherein the generating of each test case comprises receiving or generating at least one of an input value of each test case, an execution condition, an expected value, and a stub code which is generated by processing a specific code to be compilable and which replaces a specific function.

21. The method of claim 18, wherein the code for each test case comprises a test case template code.
